(19) United States
(12) Patent Application Publication
(10) Pub. No.: US 2015/0202793 A1
(43) Pub. Date: Jul. 23, 2015

(54) METHOD FOR PRODUCTION OF BUILDING MATERIAL CONTAINING FIBER CEMENT

(71) Applicant: DALSAN YATIRIM VE INSAAT ANONIM SIRKETI, Ankara (TR)

(72) Inventor: Mehmet Bahattin Daloglu, Ankara (TR)

(73) Assignee: DALSAN YATIRIM VE INSAAT ANONIM SIRKETI, Ankara (TR)

(21) Appl. No.: 14/420,455

(22) PCT Filed: Jun. 10, 2014
(86) PCT No.: PCT/IB2014/062090

§ 371 Date: Feb. 9, 2015

(30) Foreign Application Priority Data
Jun. 10, 2013 (TR) 2013/06987

(51) Int. Cl. B28B 13/02; B28B 1/24

(52) U.S. Cl. CPC B28B 13/021; B28B 1/24

(57) ABSTRACT

The present invention relates to a method for economically producing a building material containing fiber cement having different patterns used for indoor and outdoor claddings of the buildings in a short time. By performing said inventive method it is possible to produce building materials having variety of surface patterns and/or having different patterns on their faces.

### TECHNICAL FIELD

The present invention relates to method for economically producing a building materials containing cement with fibers having different patterns on their faces used for indoor and outdoor cladding of the buildings in a short time.

### BACKGROUND OF THE INVENTION

Nowadays indoor and outdoor of the buildings or facades are covered with building materials containing fiber cement having plane or wooden patterns for isolation or visual aspects. Fiber cement composition generally comprises cement, a filler material, natural cellulose and/or polyvinyl acetate (PVA) and synthetic fiber like carbon fiber or glass fiber.

Today building materials containing fiber cement are generally produced by using Hatscheck method. According to said method there are pluralities of vessels having fiber cement mud inside and rotating vacuum filter drums placed above the said vessels. While the drums are rotating they take the mud from the vessels by the effect of the vacuum and layered muddy fluid are transferred from one drum to another following drum. There is a blade on the last drum and layered solidified product can be cut by said blade for being sized. After being sized in a layered manner the product can be transferred to an area having huge pressing machines and by the help of said pressing machines only a single face of the product can be patterned.

Since the high setup cost, it is feasible to use Hatscheck method only for high volume production. In addition to this, only a limited number of patterns can be given to the single face of the products. Since pressing is used for giving patterns, it is economically impossible to use Hatscheck method for giving a variety of patterns to the face of the products. Moreover, products produced by using Hatscheck method have standard geometrical shapes like rectangular, square etc. For having a different geometrical shapes an additional members have to be used during the production. For this reason a plurality of overlapped building materials have to be used for increasing the covering efficiency during the cladding process. For this reason too many building materials are used during cladding process and this increases the covering cost.

The U.S. Pat. No. 8,329,308 discloses a cementitious article and a method of making a cementitious article. The cementitious article comprises a cementitious component that comprises a polyvinyl acetate type polymer, a monobasic phosphate, and optionally boric acid. Cementitious articles, such as board, are prepared such that the polyvinyl acetate type polymer, the monobasic phosphate, and optionally boric acid can be present in the cementitious core, and/or in dense layers if present. The concentration of the polyvinyl acetate type polymer, monobasic phosphate, and optionally boric acid in the cementitious article can increase from a central region A to peripheral regions B and C, respectively. In some embodiments, the polyvinyl acetate type polymer is a polyvinyl alcohol and the monobasic phosphate is monoammonium phosphate.

The European patent document EP2527051 discloses a composite material, process for its production and composition of said material. Said composite material that seales the asbestos fibres, obtained by embedding in plastics waste, such as plastic material wastes, asbestos-cement, grinded wastes of asbestos-cement having good workability, intended to obtain manufactured goods. The composite material comprises: a matrix made of a plastic selected from the group consisting of PVC, PE, PP or PET, and grinded asbestos-cement, preferably 20% by weight, the grinded asbestos-cement having a granulation of 2 micrometers-0.4 mm, preferably 2-5 micrometers. Composition containing the above-mentioned composite material and one or more adhesives, optionally chrysotile fibres, and alumina. The invention also refers to a process of obtaining the composite material by injection into the die, which consists of mixing the plastic materials granules together grinded asbestos-cement, bringing to the melting temperature of the plastic material, mixing of the mixture, pressure casting into a die with material tail/cushion and cooling the composite product in the die.

### SUMMARY OF THE INVENTION

Objective of the invention is to realize a method for economically producing a building materials containing fiber cement which are used for covering the indoor and outdoor facades of the buildings in a short time.

Another objective of the invention is to realize a method for producing a building materials containing fiber cement which are used for covering the indoor and outdoor facades of the buildings having variety of different patterns.

Another objective of the invention is to realize a method for producing a building materials containing fiber cement which are used for covering the indoor and outdoor facades of the buildings having different patterns on their both faces.

Another objective of the invention is to realize a method which provides using minimum number of building materials during the covering the indoor and outdoor facades of the buildings.

Another objective of the invention is to realize a method which provides high amount of heat isolation efficiency by reducing the heat transfer between indoor and outdoor of the building.

### DETAILED DESCRIPTION OF THE INVENTION

“A Method for Production of Building Material Containing Fiber Cement” realized to fulfill the objective of the present invention is shown in the figure attached, in which:

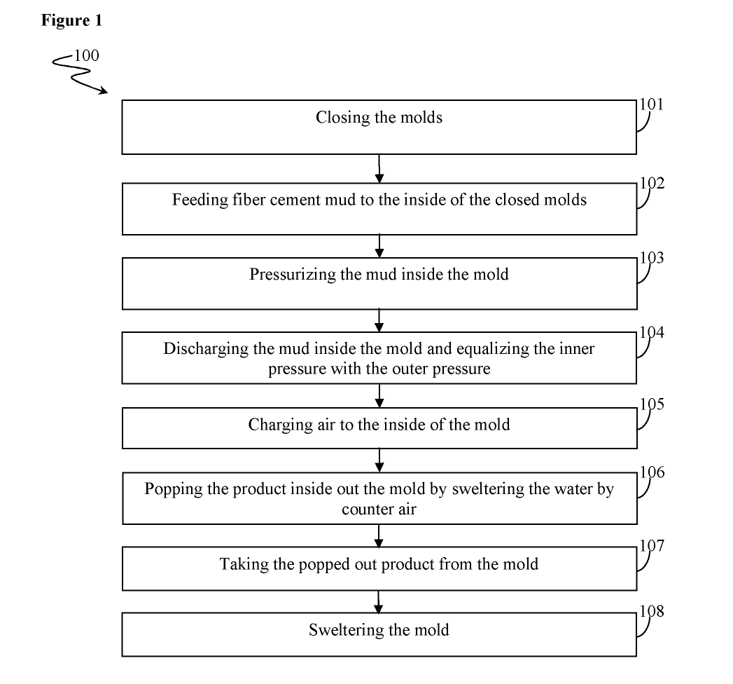

FIG. 1 is a flow chart of the inventive method.

A method (100) for producing building materials basically containing cement, a filler material, natural cellulose and/or polyvinyl acetate (PVA) and synthetic fiber like carbon fiber or glass fiber comprise the steps of;

closing the molds (101),

feeding fiber cement mud to the inside of the closed molds (102),

pressurizing the mud inside the mold (103),

discharging the mud inside the mold and equalizing the inner pressure with the outer pressure (104),

charging air to the inside of the mold (105),

popping the product inside out the mold by sweltering the water by counter air (106),

taking the popped out product from the mold (107) and

sweltering the mold (108).

In the inventive method (100) first the mold in which the building material will be produced is closed (101). Said mold may have a similar characteristics with the mold used for producing lavatory pan disclosed in EP1273406. The molds used in the disclosed inventive method (100) have a micro porous spongy structure. After the mold is closed (101), fluidic fiber cement mud containing cement, a filler material, natural cellulose and/or polyvinyl acetate (PVA) and synthetic fiber like carbon fiber or glass fiber is fed into the mold (102) preferably by the help of a pump. After feeding the mud inside the mold (102), the valves providing the feeding of the mud are closed and the mud inside the mold is pressurized by using any technique known in the prior art suitable for the mud inside the mold by the help of a pump (103). If it is deserved pressurizing process can be done at different pressure values and times in order to adjust the densification of the mud inside the mold. While pressure inside the mold is increasing, water inside the mud moves toward to inside of the mold and mud from which the water leaving gets solidified. Pressurizing process (103) continues until the deserved thickness is satisfied. At the point that the deserved thickness is satisfied, i.e. water necessary for the deserved thickness is transferred to the porous mold, discharging valve is opened and surplus amount of the mud leaves the mold and inside pressure of the mold is equalized with the outer pressure (104). After discharging the surplus amount of mud and equalizing the inside pressure of the mold with the outside pressure, a fluid, preferably air, is fed to the porous mold reversely by the help of a valve (105). By reversely feeding the fluid into the mold (105), the water penetrated into the mold starts to move in reverse direction and presses the solidified mud, i.e. building material. After necessary water pressure is satisfied, solidified mud, i.e. building material, is popped out to mold (106) and popped out product is taken from the mold manually or by the help of automatic machines (107). After the product is taken from the mold (107), the mold is finally sweltered (108) and prepared for the next processes. After the building material is taken from the mold (107), process will be started from step 101 if another building material is deserved to be produced.

In the disclosed inventive method (100) faces of the building material can be patterned depending on the pattern situated on the surface of the mold. By this way it is possible to produce building materials having variety of patterns on their faces economically which is not economically possible in the Hatscheck method because of necessity of the changing of the pressing machines in order to obtain pattern variety. Moreover, it is possible to obtain building materials having different patterns on their faces by using molds having more than one pattern.

In the disclosed inventive method (100) it is possible to produce building materials having deserved geometric shapes by shaping the surface of the used mold. For example, there are some recesses on the surfaces of some molds and also there are suitable protrusions matching with the said recesses on the surfaces of the other molds. By this way it is possible to produce building materials having recesses by using molds having recessed surfaces and to produce building materials having protrusions by using molds having protruded surfaces. By producing building materials having recesses and protrusions it is possible to overcome the overlapped cladding problem in the prior art. By this way it is possible to coat buildings by using less building materials, so that cladding process becomes more economical.

Moreover, using building materials having recesses and protrusions during the cladding process allows decreasing the heat transfer rate between inside and outside of the building and this provides more efficient heat isolation.

By using the inventive method (100) of producing building materials containing fiber cement which comprises the step of pressurizing the fiber cement placed in the mold that leads to the movement of the water inside the mud to the porous mold surface that enables the mud to solidify, it is possible to produce building materials having variety of surface patterns and geometrical shapes by using the molds having variety of surface patterns and geometrical shapes during the cladding process in a short time and economically.

It is possible to develop various embodiments of the inventive method (100), it cannot be limited to examples disclosed herein and it is essentially according to claims.

1. A method (100) for producing building materials basically containing cement, a filler material natural cellulose and/or polyvinyl acetate (PVA) and synthetic fiber like carbon fiber or glass fiber is characterized by the steps of;
closing the molds (101),
feeding fiber cement mud to due inside of the closed molds (102),
pressurizing the mud inside the mold (103),
discharging the mud inside the mold and equalizing the inner pressure with the outer pressure (104),
charging it to the inside of the mold (105),
popping the product inside out the mold by sweltering due water by counter air (106),
taking the popped out product born the mold (107) and sweltering the mold 108).

2. A method (100) according to claim 1 wherein the fiber cement mud is fed into the mold by a pump.

3. A method (100) according to claim 1, wherein feeding valves providing the feeding of the mud into the mold are closed and the mud inside the mold is pressurized by feeding air into the mold after feeding fiber cement mud to the inside of the molds (102).

4. A method (100) according to claim 3, wherein the water inside the mud moves toward the porous surface of the mold which leads solidifying of the mud.

5. A method (100) according to claim 3, wherein pressurizing process (103) continues until time deserved thickness of the mud is realized.

6. A method (100) according to claim 5, wherein mud discharging valve is opened tor discharging the surplus amount of mud and inside pressure of the mold is equalized with the outside pressure when the deserved thickness is realized.

7. A method (100) according to claim 6 wherein a fluid, preferably an air, is fed into the porous structure of the mold reversely when mud discharging valve is opened for discharging the surplus amount of mud and inside pressure of the mold is equalized with the outside pressure.

8. A method (100) according to claim 7 wherein the water penetrated into the mold starts to move in reverse direction and presses the solidified mud when the fluid is fed to the porous structure reversely.

9. A method according to claim 8, wherein solidified mud is popped the mold out when the necessary water pressure for achieving deserved thickness is satisfied.

10. A method (100) according to claim 9, wherein popped out product is taken from the mold manually or by the help of automatic machines and the mold is sweltered.

11. A method (100) according to claim 1, wherein during the production the mold having patterned surfaces is used in order to give a desired pattern on the faces of the building materials.

12. A method (100) according to claim 1, wherein the molds suitable for production of building materials that have different patterns on their faces is used.

13. A method (100) according to claim 1, wherein during the production the mold having any geometrical shape in its surface is used in order to give a desired geometrical shape to the building material.
